(19) United States
(12) Patent Application Publication
(10) Pub. No.: US 2004/0210446 A1
(43) Pub. Date: Oct. 21, 2004

(54) Allocating items among a heterogeneous group of buyers

(75) Inventor: Manoel Tenorio, Mountain View, CA (US)

Correspondence Address: Baker Botts L.L.P., Suite 600, 2001 Ross Avenue, Dallas, TX, 75201-2980, US

(73) Assignee: i2 Technologies US, Inc.

(21) Appl. No.: 09/948,320

(22) Filed: Sep. 6, 2001

(51) Int. Cl. G06F 17/60

(52) U.S. Cl. 705/1

(57) ABSTRACT

In one embodiment of the present invention, a system for allocating a plurality of items among a group of buyers includes computers that determine sets of buyers within the group. The computers prioritize among the sets of buyers and prioritize among the buyers within each set of buyers and allocate items among the group of buyers. Each buyer within a higher-priority set of buyers is allocated an item quantity before buyers within a lower-priority set of buyers are allocated an item quantity and items are allocated among buyers within a set of buyers in a series of rounds in which a higher-priority buyer is allocated a pre-determined quantity of items matching preferences for the higher-priority buyer before a lower-priority buyer is allocated the pre-determined quantity of items matching preferences for the lower-priority buyer, each round continuing until every buyer within the set of buyers has been allocated the pre-determined quantity of items in the round, the series of rounds continuing until each buyer within the set of buyers has been allocated a quantity of items.

### TECHNICAL FIELD OF THE INVENTION

This invention relates generally to electronic commerce and more particularly to allocating items among a heterogeneous group of buyers.

### BACKGROUND OF THE INVENTION

In an unbalanced market, there may be fewer market participants on one side of the market than the other, and those market participants may each have a capacity to buy or sell that is substantially greater than the capacity of any individual market participants on the other side of the market to sell or buy, respectively. In such a market, the larger-capacity market participants on the less populous side of the market may have substantially greater control over market prices, substantially greater bargaining power, and other advantages over the smaller-capacity market participants on the more populous side of the market. To lessen the effects of these and other possible market disadvantages, two or more smaller-capacity market participants may combine their market capacities and participate in the market as a single market entity, which may give them a more advantageous market presence.

While there may be benefits to such group buying or group selling, there may also be one or more drawbacks. For example, it may be difficult to allocate bought items among a group of buyers in a manner that substantially rewards individual members for their respective contributions to the market capacity of the group without substantially penalizing buyers for not making substantially large contributions to the market capacity of the group. It may also be difficult to achieve a satisfactory allocation of items among a group of buyers where the bought items differ from each other in one or more ways and the buyers each have different preferences pertaining to the bought items.

### SUMMARY OF THE INVENTION

According to the present invention, disadvantages and problems associated with previous group buying techniques may be substantially reduced or eliminated.

In one embodiment of the present invention, a system for allocating a plurality of items among a group of buyers includes computers that determine sets of buyers within the group. The computers prioritize among the sets of buyers and prioritize among the buyers within each set of buyers and allocate items among the group of buyers. Each buyer within a higher-priority set of buyers is allocated an item quantity before buyers within a lower-priority set of buyers are allocated an item quantity and items are allocated among buyers within a set of buyers in a series of rounds in which a higher-priority buyer is allocated a pre-determined quantity of items matching preferences for the higher-priority buyer before a lower-priority buyer is allocated the pre-determined quantity of items matching preferences for the lower-priority buyer, each round continuing until every buyer within the set of buyers has been allocated the pre-determined quantity of items in the round, the series of rounds continuing until each buyer within the set of buyers has been allocated a quantity of items.

Particular embodiments of the present invention may provide one or more technical advantages. For example, particular embodiments may provide a substantially fair allocation of bought items among a heterogeneous group of buyers. Particular embodiments may also provide an allocation of bought items among a group of buyers that takes into account a variety of pricing, preference, and other buyer constraints. Particular embodiments may also allow items to be allocated among a heterogeneous group of buyers in a way that substantially achieves peer equality within the group where the bought items are also heterogeneous. Particular embodiments may produce a substantially fair allocation where the pricing of bought items is causal (meaning quantity-independent). Particular embodiments may produce an allocation of bought items that substantially rewards individual members for their respective contribution to the market capacity of the group without substantially penalizing buyers unable to make substantially large contributions to the market capacity of group.

Systems and methods incorporating one or more of these or other technical advantages may be well suited for modem electronic commerce environments. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates an example system supporting group buying;

FIG. 2 illustrates an example buying group;

FIG. 3 illustrates an example plot of items along two example axes; and

FIG. 4 illustrates an example method for allocating items among buyers within a buying group.

### DETAILED DESCRIPTION OF EXAMPLE EMBODIMENTS

FIG. 1 illustrates an example system 10 supporting group buying. System 10 may include one or more buyers 12, one or more sellers 14, and an electronic marketplace 16 associated with a website or other environment accessible to buyers 12 and sellers 14. In general, electronic marketplace 16 may receive offers to buy from buyers 12 and offers to sell from sellers 14 and match an appropriate offer to buy with an appropriate offer to sell, initiating a transaction between the corresponding buyer 12 and seller 14. Although buyers 12 and sellers 14 are described as separate entities, a buyer 12 in one transaction may be a seller 14 in another transaction, and vice versa. Moreover, reference to “buyer” or “seller” may include a person, a computer system, an enterprise, or any other buying or selling entity, as appropriate. For example, buyer 12 may include a computer programmed to autonomously identify a need for an item, search for that item, and buy that item upon identifying a suitable seller 14. Reference to “items” may include raw materials, component parts, products, or other tangible or intangible things that may be the subject of a transaction between buyer 12 and seller 14. Additionally, “items” may include lots, blocks, bundles, bushels, or other suitable units of one or more individual items, where appropriate. For example, capacitors may be bought and sold in indivisible units of 500 capacitors, instead of one capacitor at a time. Although buying and selling are primarily described herein, the present invention contemplates any appropriate market transaction.

Buyers 12, sellers 14, and electronic marketplace 16 may be coupled to each other using links 18 that may each include one or more local area networks (LANs), metropolitan area networks (MANs), wide area networks (WANs), a portion of the Internet, or any other appropriate wireline, optical, wireless, or other link. The components of electronic marketplace 16 may operate on one or more computers at one or more locations, and electronic marketplace 16 may share one or more computers or other resources with one or more buyers 12 or one or more sellers 14, according to particular needs. Offers to buy and offers to sell may be received by electronic marketplace 16 in any suitable format, such as in the form of Hypertext Markup Language (HTML), Extensible Markup Language (XML), or other suitable files within Hypertext Transport Protocol (HTTP) or other messages.

Associated with electronic marketplace 16, at one or more locations integral to or separate from electronic marketplace 16, may be one or more market servers 20, each supporting a particular electronic market for a particular item or class of items. For example, a particular market server 20 may receive offers to buy from buyers 12 and offers to sell from sellers 14, prioritize such offers, match appropriate offers to buy with appropriate offers to sell, initiate a transaction between a corresponding buyer 12 and seller 14 when a match has occurred between an offer to buy and an offer to sell, and perform other suitable tasks associated with supporting an electronic market.

Electronic markets supported by electronic marketplace 16 may be unbalanced. In an unbalanced market, as described above, the larger-capacity market participants on the less populous side of the market may have substantially greater control over market prices, substantially greater bargaining power, and other advantages over the smaller-capacity market participants on the more populous side of the market. To lessen the effects of these and other possible market disadvantages, two or more smaller-market participants may combine their market capacities and participate in the market as a single market entity, which may give them a more advantageous market presence and possibly provide other advantages.

For example, a particular electronic market supported by electronic marketplace 16 may include a relatively small number of larger-capacity sellers 14 and a relatively large number of smaller-capacity buyers 12. To compensate for their smaller market capacities and to reduce competition among them, two or more buyers 12c may combine their market capacities and participate in the market as a single market entity, example buying group 22. Each buyer 12c within buying group 22 may request a particular quantity of items and may be allocated from among the total quantity of items bought for buying group 22 a quantity of items that is substantially equal to the quantity requested by that buyer 12c. A group leader (which may be a member of buying group 22) or other representative of buying group 22 may buy items from one or more sellers 14 for buying group 22 according to some arrangement among buyers 12c. For example, the representative of buying group 22 may buy a quantity of items substantially equal to the sum of the quantities requested by buyers 12c at the lowest possible prices from one or more sellers 14. Additionally, certain restrictions may be placed on the representative of buying group 22. For example, the representative of buying group 22 may be instructed not to buy from certain sellers 14 or not to buy more than a pre-determined quantity of items from any one seller 14. The present invention contemplates any suitable restrictions on the representative of buying group 22 according to particular needs.

Items bought for buying group 22 may be heterogeneous. For example, items bought for buying group may differ from each other in terms of per-item price, associated delivery time, seller location, or other aspects. Additionally, buyers 12c within buying group 22 may be heterogeneous such that each buyer 12c may have different preferences pertaining to the items bought for buying group 22, which preferences may be stored as buyer preference information 24 in one or more databases accessible to allocation server 26, described more fully below. For example, one buyer 12c may prefer items having an associated delivery time between five and ten days, while another buyer 12c may prefer items having an associated delivery time between three and six days. There may also be universal preferences for buyers 12c within buying group. For example, each buyer 12c within buying group 22 may prefer less expensive items over more expensive items. Preferences for buyers 12c may include “must have” and “cannot have” preferences and may include complex preferences involving multiple parameters and multiple parameter values. For example, a preference for a particular buyer 12c may indicate that a delivery time of more than ten days for a particular item of items is acceptable only if the per-item price is below $5. Another preference for buyer 12c may indicate that a price of greater than $7 is acceptable only if the location of the seller is within Texas, Oklahoma, Arkansas, or Louisiana, but that a price over $8.50 is unacceptable regardless of the location of the seller. Moreover, preferences for buyer 12c may vary over the total quantity requested by buyer 12c. For example, a preference for buyer 12c may indicate that a delivery time of fifteen days is acceptable only if buyer 12c has already been allocated twenty items having an associated delivery time of five or fewer days. The present invention contemplates any suitable preferences for buyers 12c according to particular needs.

Due to the possible heterogeneity of the items bought for buying group 22, the possible heterogeneity of buyers 12c within buying group 22, and possibly other reasons, it may be difficult to achieve a satisfactory allocation of bought items among buyers 12c. Additionally, it may be difficult to achieve an allocation that substantially rewards individual buyers 12c for their respective contributions to the market capacity of buying group 22 without substantially penalizing buyers 12c for not making substantially large contributions to the market capacity of buying group 22. To facilitate the allocation of bought items among buyers 12c within buying group 22, electronic marketplace 16 may include one or more allocation servers 26 that may allocate items among buyers 12c according to a suitable algorithm. In one embodiment, for example, allocation server 26 may, as described more fully below, allocate items among buyers 12c by determining one or more “quantity leader” sets that each include one or more buyers 12c, prioritizing among the determined quantity leader sets, prioritizing among buyers 12c within each quantity leader set, and allocating bought items among buyers 12c according to the prioritization of the quantity leader sets, the prioritization of buyers 12c within each quantity leader set, and the preferences for each buyer 12c.

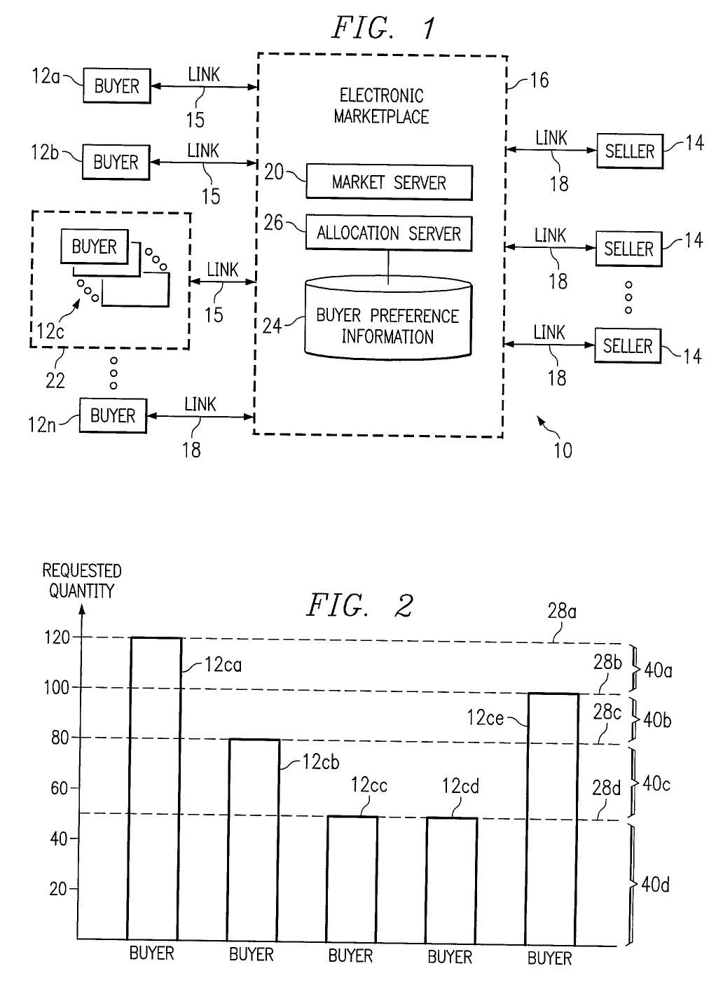

FIG. 2 illustrates example buying group 22. For example only and not by way of limitation, buying group 22 may include five buyers 12c, each having requested a particular quantity of items. As shown, buyer 12ca has requested one hundred twenty items, buyer 12cb has requested eighty items, buyers 12cc and 12cd have each requested fifty items, and buyer 12ce has requested one hundred items. Each quantity requested by one or more buyers 12c may define a quantity level. For example, the quantities requested by buyers 12c within buying group 22 may define quantity level 28a of one hundred twenty items, quantity level 28b of one hundred items, quantity level 28c of eighty items, and quantity level 28d of fifty items. As described above, allocation server 26 may determine one or more quantity leader sets. Each quantity leader set may be associated with two successive quantity levels 28 (meaning that no quantity level separates the two quantity levels 28) that together define a quantity range 40 and a quantity difference. Each quantity leader set may include one or more buyers 12c that have each requested a quantity of items that exceeds the lower of the two associated quantity levels 28, and a particular buyer 12c may be in more than one quantity leader set.

Within buying group 22, for example, a first quantity leader set may be associated with quantity levels 28a and 28b and may include buyer 12ca, quantity range 40a for the first quantity leader set may be one hundred to one hundred twenty items, and the quantity difference for the first quantity leader set may be twenty items. A second quantity leader set may be associated with quantity levels 28b and 28c and may include buyers 12ca and 12ce, quantity range 40b for the second quantity leader set may be eighty to one hundred items, and the quantity difference for the second quantity leader set may be twenty items. A third quantity leader set may be associated with quantity levels 28c and 28d and may include buyers 12ca, 12cb, and 12ce, quantity range 40c for the third quantity leader set may be fifty to eighty items, and the quantity difference for the third quantity leader set may be thirty items. A fourth quantity leader set may be associated with quantity level 28d and a base quantity level (which may be zero items) and may include buyers 12ca, 12cb, 12cc, 12cd, and 12ce, quantity range 40d for the fourth quantity leader set may be zero to fifty items, and the quantity difference for the first quantity leader set may be fifty items.

Allocation server 26 may prioritize among quantity leader sets, as briefly described above. In one embodiment, a quantity leader set associated with a higher quantity range 40 may be given a higher priority than a quantity leader set associated with a lower quantity range 40. Among the example quantity leader sets described above, for example, the first quantity leader set may be given first priority, the second quantity leader set may be given second priority, the third quantity leader set may be give third priority, and the fourth quantity leader set may be given fourth priority. Additionally, allocation server 26 may prioritize among buyers 12c within each quantity leader set. In one embodiment, buyer 12c that has requested a larger quantity of items may be given a higher priority than buyer 12c that has requested a smaller quantity of items. For example, in each example quantity leader set described above in which the following buyers 12c are included, buyer 12ca may be given first priority, buyer 12ce may be given second priority, buyer 12cb may be given third priority, and buyers 12cc and 12cd may be each be given fourth priority (alternatively, allocation server 26 may prioritize among buyers 12c that have requested substantially equal quantities using a suitable “tie-breaking” technique).

As described above, allocation server 26 may allocate bought items among buyers 12c within buying group 22 according to the prioritization of the determined quantity leader sets and the prioritization of the buyers 12c within each quantity leader set. In one embodiment, a pre-determined quantity of items may be allocated to each buyer 12c within a quantity leader set associated with a higher quantity range 40 before a pre-determined quantity of items may be allocated to each buyer 12c within a quantity leader set associated with a lower quantity range 40. The pre-determined quantity of items allocated to each buyer 12c within a quantity leader set may be substantially equal to the quantity difference for the quantity leader set. Within a quantity leader set, items may be allocated among buyers 12c within the quantity leader set in a series of rounds in which a higher-priority buyer 12c may be allocated a quantity of items that is less than the quantity difference for the quantity leader set before a lower-priority buyer 12c may be allocated the same quantity of items. Each such round may continue until each buyer 12c within the quantity leader set has been allocated the quantity of items, and the series of rounds may continue until each buyer 12c within the quantity leader set has been allocated the pre-determined quantity of items substantially equal to the quantity difference for the quantity leader set.

For example, items bought for buying group 22 may be distributed among buyers 12c as follows. Allocation server 26 may begin with the first quantity leader set and allocate twenty items to buyer 12ca (buyer 12ca is the only buyer 12c within the first quantity leader set). Allocation server 26 may then proceed to the second quantity leader set and allocate, in the following order, one item to buyer 12ca, one item to buyer 12ce, one item to buyer 12ca, one item to 12ce, and so on, until buyers 12ca and 12ce have each been allocated twenty items. Allocation server 26 may then proceed to the third quantity leader set and allocate, in the following order, one item to buyer 12ca, one item to buyer 12ce, one item to buyer 12cb, one item to buyer 12ca, one item to buyer 12ce, one item to buyer 12cb, and so on, until buyers 12ca, 12ce, and 12cb have each been allocated thirty items. Allocation server 26 may then proceed to the fourth quantity leader set and allocate, in the following order, one item to buyer 12ca, one item to buyer 12ce, one item to buyer 12cb, one item to buyer 12cc, one item to buyer 12cd, one item to buyer 12ca, one item to buyer 12ce, one item to buyer 12cb, one item to buyer 12cc, one item to buyer 12cd, and so on, until buyers 12ca, 12ce, 12cb, 12cc and 12cd have each been allocated fifty items. (As described above, the order in which buyers 12cc and 12cd are allocated items may be determined using a suitable tie-breaking technique. Alternatively or in addition, the order in which buyers 12cc and 12cd are allocated items may alternate from round to round.) In this way, each buyer 12c within buying group may be allocated a quantity of items substantially equal to their respective requested quantities.

When allocating one or more items to a particular buyer 12c, allocation server 26 may locate among the available items (meaning those items that have not yet been allocated to a particular buyer 12c) the one or more items providing a substantial match with one or more preferences for buyer 12c, which match may be the best match possible among the available units. Allocation server 26 may use any suitable matching technique to locate items providing a substantial match with one or more preferences for buyer 12c.

FIG. 3 illustrates an example plot 30 of items along two example axes 32. Allocation server 26 may generate example plot 30 to match available items with preferences for buyers 12c. Axes 32 may each represent a particular attribute of the items bought for group 22. For example, axis 32a may represent delivery time and axis 32b may represent per-item price. Although example plot 30 includes two particular axes 32, the present invention contemplates any suitable number of axes 32 representing any suitable attributes that may be associated with items bought for group 22. Points 34, each corresponding to an available quantity of items having a particular combination of attribute values (meaning specific instances of attributes associated with items bought for buying group 22) may be placed along axes 32 in accordance with their respective attribute values. For example, point 34a may correspond to available items costing $2 per item and having an associated delivery time of six days. Associated with each point 34 may be quantity indicator 36 indicating the available quantity of items having the combination of attribute values corresponding to that point 34. For example, quantity indicator 36a may indicate that there are twenty available items costing $2 per item and having an associated delivery time of six days.

Allocation server 26 may also generate “hyperplane” 38, which may embody any suitable combination of preferences for buyer 12c. For example, the slope of hyperplane 38 may represent a preferential combination of per-item price and delivery time for buyer 12c. Additionally or as an alternative, hyperplane 38 may embody any suitable combination of preferences for buyer 12c by virtue of the shape, color, length, or other suitable aspect of hyperplane 38, such as gaps, holes, or contours included in hyperplane 38. Although example hyperplane 38 is described herein, the present invention contemplates any suitable hyperplane embodying any suitable combination of preferences for buyer 12c in any suitable way. In addition or as an alternative to hyperplane 38, one or more preferences for buyer 12c may be represented by a suitable combination of one or more areas of inclusion 40 and one or more areas of exclusion 42. Areas of inclusion 40 may correspond to one or more ranges of attribute values acceptable to buyer 12c, and items corresponding to points 34 within areas of inclusion 40 may be allocated to buyer 12c. In contrast, areas of exclusion 42 may correspond to one or more ranges of attribute values unacceptable to buyer 12c, and items corresponding to points 34 within areas of exclusion 42 may not be allocated to buyer 12c. Areas of inclusion 40 and areas of exclusion 42 may also be used to represent “must have” and “cannot have” preferences, respectively, for buyer 12c. To locate among the available items bought for buying group 22 a substantial match with one or more preferences for a particular buyer 12c, allocation server 26 may move hyperplane 38 through plot 30 in a suitable manner until hyperplane 38 encounters a suitable point 34. Upon encountering a suitable point 34, allocation server 26 may allocate to buyer 12c a suitable quantity of items corresponding to point 34 and adjust the corresponding quantity indicator 36 accordingly.

Although plot 30, hyperplane 38, and the moving of hyperplane 38 through plot 30 have been described, the present invention contemplates a substantial match with one or more preferences for a particular buyer 12c being located among available items bought for buying group 22 using any suitable technique. For example, such a match may be located entirely within data, without generating plot 30 or hyperplane 38 or otherwise graphically representing items or buyer preferences or moving hyperplane 38 through plot 30.

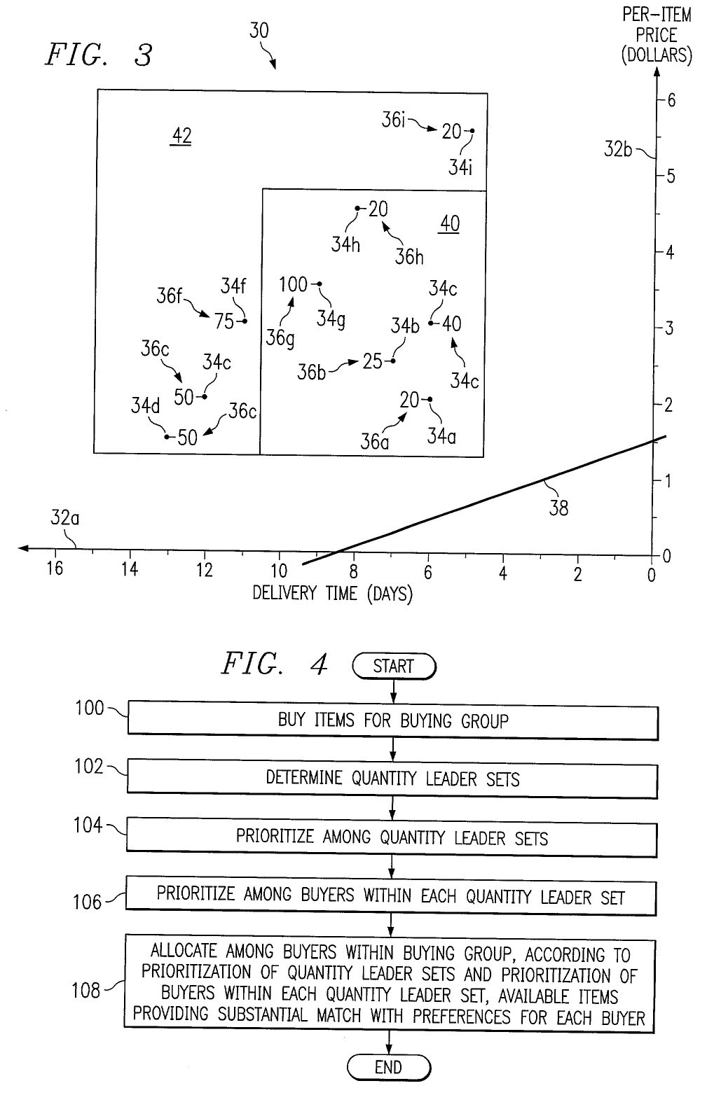

FIG. 4 illustrates an example method for allocating items among buyers 12c within buying group 22. The method begins at step 100 where items are bought for buying group 22. At step 102, allocation server 26 determines one or more quantity leader sets for buying group 22. Although allocation server 26 is particularly described as performing certain tasks associating with allocating items among buyers 12c within buying group 22, the present invention contemplates any suitable combination of devices internally or externally associated with electronic marketplace 16 performing such tasks. Allocation server 26 prioritizes among the determined quantity leader sets at step 104 and, at step 106, prioritizes among buyers within each quantity leader set. At step 108, allocation server allocates among buyers 12c within buying group 22, according to the prioritization of the determined quantity leader sets and the prioritization of buyers 12c within each determined quantity leader set, available units of items providing a suitable match with one or more preferences for each buyer within buying group 22, and the method ends.

Although the present invention has been described with several embodiments, divers changes, substitutions, variations, alterations, and modifications may be suggested to one skilled in the art, and it is intended that the invention may encompass all such changes, substitutions, variations, alterations, and modifications falling within the spirit and scope of the appended claims.

What is claimed is:

1. A system for allocating a plurality of items among a group of buyers, each item having one or more attribute values, the attribute values generally varying from item to item, each buyer within the group having one or more preferences, the preferences generally varying from buyer to buyer, each buyer within the group having requested a quantity of items, the requested quantities generally varying from buyer to buyer, there being a series of quantity levels each defined by a quantity requested by one or more buyers, the system comprising one or more computers collectively operable to:
determine a plurality of sets of buyers within the group of buyers, each set of buyers being associated with two successive quantity levels together defining a quantity range and a quantity difference, each set of buyers comprising one or more buyers that have each requested a quantity of items that exceeds the lower of the two successive quantity levels;
prioritize among the plurality of determined sets of buyers, a set of buyers that is associated with a higher quantity range being given a higher priority than a set of buyers that is associated with a lower quantity range;
prioritize among the buyers within each set of buyers, a buyer that has requested a larger quantity of items being given a higher priority than a buyer that has requested a smaller quantity of items; and
allocate items among the group of buyers according to an algorithm such that:
each buyer within a higher-priority set of buyers is allocated an item quantity that is substantially equal to the quantity difference for the higher-priority set of buyers before buyers within a lower-priority set of buyers are allocated an item quantity that is substantially equal to the quantity difference for the lower-priority set of buyers, and
items are allocated among buyers within a set of buyers in a series of rounds in which a higher-priority buyer within the set of buyers is allocated a pre-determined quantity of items substantially matching the one or more preferences for the higher-priority buyer before a lower-priority buyer within the set of buyers is allocated the pre-determined quantity of items substantially matching the one or more preferences for the lower-priority buyer, the pre-determined quantity of items being substantially less than the quantity difference for the set of buyers, each round continuing until every buyer within the set of buyers has been allocated the pre-determined quantity of items in the round, the series of rounds continuing until each buyer within the set of buyers has been allocated a quantity of items substantially equal to the quantity difference for the set of buyers.

2. The system of claim 1, wherein the attribute values for an item comprise price and delivery time.

3. The system of claim 1, wherein a substantial match between an item and the one or more preferences for a buyer comprises the best possible match among the items with the one or more preferences for the buyer.

4. The system of claim 1, wherein the pre-determined quantity of items is one item.

5. The system of claim 1, wherein the one or more preferences for a buyer comprise required attribute values and unacceptable attribute values for items.

6. The system of claim 1, wherein the one or more preferences for a buyer comprise one or more attribute values for items, the acceptability of which is dependent on one or more other attribute values for these items.

7. The system of claim 1, wherein the one or more preferences for a buyer may vary over the entire quantity requested by the buyer.

8. The system of claim 1, wherein the computers are collectively operable to:
establish a preference plane that embodies one or more preferences for a buyer; and
move the preference plane through a space containing a plurality of data points each associated with a particular quantity of items and a particular combination of attribute values for the items to identify one or more items that substantially match the one or more preferences for the buyer.

9. The system of claim 8, wherein the space includes areas of inclusion and areas of exclusion relating to the one or more preferences for the buyer.

10. A method for allocating a plurality of items among a group of buyers, each item having one or more attribute values, the attribute values generally varying from item to item, each buyer within the group having one or more preferences, the preferences generally varying from buyer to buyer, each buyer within the group having requested a quantity of items, the requested quantities generally varying from buyer to buyer, there being a series of quantity levels each defined by a quantity requested by one or more buyers, the method comprising:
determining a plurality of sets of buyers within the group of buyers, each set of buyers being associated with two successive quantity levels together defining a quantity range and a quantity difference, each set of buyers comprising one or more buyers that have each requested a quantity of items that exceeds the lower of the two successive quantity levels;
prioritizing among the plurality of determined sets of buyers, a set of buyers that is associated with a higher quantity range being given a higher priority than a set of buyers that is associated with a lower quantity range;
prioritizing among the buyers within each set of buyers, a buyer that has requested a larger quantity of items being given a higher priority than a buyer that has requested a smaller quantity of items; and
allocating items among the group of buyers according to an algorithm such that:
each buyer within a higher-priority set of buyers is allocated an item quantity that is substantially equal to the quantity difference for the higher-priority set of buyers before buyers within a lower-priority set of buyers are allocated an item quantity that is substantially equal to the quantity difference for the lower-priority set of buyers, and
items are allocated among buyers within a set of buyers in a series of rounds in which a higher-priority buyer within the set of buyers is allocated a pre-determined quantity of items substantially matching the one or more preferences for the higher-priority buyer before a lower-priority buyer within the set of buyers is allocated the pre-determined quantity of items substantially matching the one or more preferences for the lower-priority buyer, the pre-determined quantity of items being substantially less than the quantity difference for the set of buyers, each round continuing until every buyer within the set of buyers has been allocated the pre-determined quantity of items in the round, the series of rounds continuing until each buyer within the set of buyers has been allocated a quantity of items substantially equal to the quantity difference for the set of buyers.

11. The method of claim 10, wherein the attribute values for an item comprise price and delivery time.

12. The method of claim 10, wherein a substantial match between an item and the one or more preferences for a buyer comprises the best possible match among the items with the one or more preferences for the buyer.

13. The method of claim 10, wherein the pre-determined quantity of items is one item.

14. The method of claim 10, wherein the one or more preferences for a buyer comprise required attribute values and unacceptable attribute values for items.

15. The method of claim 10, wherein the one or more preferences for a buyer comprise one or more attribute values for items, the acceptability of which is dependent on one or more other attribute values for these items.

16. The method of claim 10, wherein the one or more preferences for a buyer may vary over the entire quantity requested by the buyer.

17. The method of claim 10, further comprising:
establishing a preference plane that embodies one or more preferences for a buyer; and
moving the preference plane through a space containing a plurality of data points each associated with a particular quantity of items and a particular combination of attribute values for the items to identify one or more items that substantially match the one or more preferences for the buyer.

18. The method of claim 17, wherein the space includes areas of inclusion and areas of exclusion relating to the one or more preferences for the buyer.

19. Software for allocating a plurality of items among a group of buyers, each item having one or more attribute values, the attribute values generally varying from item to item, each buyer within the group having one or more preferences, the preferences generally varying from buyer to buyer, each buyer within the group having requested a quantity of items, the requested quantities generally varying from buyer to buyer, there being a series of quantity levels each defined by a quantity requested by one or more buyers, the software embodied in a computer-readable medium and when executed operable to:
determine a plurality of sets of buyers within the group of buyers, each set of buyers being associated with two successive quantity levels together defining a quantity range and a quantity difference, each set of buyers comprising one or more buyers that have each requested a quantity of items that exceeds the lower of the two successive quantity levels;
prioritize among the plurality of determined sets of buyers, a set of buyers that is associated with a higher quantity range being given a higher priority than a set of buyers that is associated with a lower quantity range;
prioritize among the buyers within each set of buyers, a buyer that has requested a larger quantity of items being given a higher priority than a buyer that has requested a smaller quantity of items; and
allocate items among the group of buyers according to an algorithm such that:
each buyer within a higher-priority set of buyers is allocated an item quantity that is substantially equal to the quantity difference for the higher-priority set of buyers before buyers within a lower-priority set of buyers are allocated an item quantity that is substantially equal to the quantity difference for the lower-priority set of buyers, and
items are allocated among buyers within a set of buyers in a series of rounds in which a higher-priority buyer within the set of buyers is allocated a pre-determined quantity of items substantially matching the one or more preferences for the higher-priority buyer before a lower-priority buyer within the set of buyers is allocated the pre-determined quantity of items substantially matching the one or more preferences for the lower-priority buyer, the pre-determined quantity of items being substantially less than the quantity difference for the set of buyers, each round continuing until every buyer within the set of buyers has been allocated the pre-determined quantity of items in the round, the series of rounds continuing until each buyer within the set of buyers has been allocated a quantity of items substantially equal to the quantity difference for the set of buyers.

20. The software of claim 19, wherein the attribute values for an item comprise price and delivery time.

21. The software of claim 19, wherein a substantial match between an item and the one or more preferences for a buyer comprises the best possible match among the items with the one or more preferences for the buyer.

22. The software of claim 19, wherein the pre-determined quantity of items is one item.

23. The software of claim 19, wherein the one or more preferences for a buyer comprise required attribute values and unacceptable attribute values for items.

24. The software of claim 19, wherein the one or more preferences for a buyer comprise one or more attribute values for items, the acceptability of which is dependent on one or more other attribute values for these items.

25. The software of claim 19, wherein the one or more preferences for a buyer may vary over the entire quantity requested by the buyer.

26. The software of claim 19, further operable to:
establish a preference plane that embodies one or more preferences for a buyer; and
move the preference plane through a space containing a plurality of data points each associated with a particular quantity of items and a particular combination of attribute values for the items to identify one or more items that substantially match the one or more preferences for the buyer.

27. The software of claim 26, wherein the space includes areas of inclusion and areas of exclusion relating to the one or more preferences for the buyer.

28. A system for allocating a plurality of items among a group of buyers, each item having one or more attribute values, the attribute values generally varying from item to item, each buyer within the group having one or more preferences, the preferences generally varying from buyer to buyer, each buyer within the group having requested a quantity of items, the requested quantities generally varying from buyer to buyer, there being a series of quantity levels each defined by a quantity requested by one or more buyers, the system comprising:
means for determining a plurality of sets of buyers within the group of buyers, each set of buyers being associated with two successive quantity levels together defining a quantity range and a quantity difference, each set of buyers comprising one or more buyers that have each requested a quantity of items that exceeds the lower of the two successive quantity levels;
means for prioritizing among the plurality of determined sets of buyers, a set of buyers that is associated with a higher quantity range being given a higher priority than a set of buyers that is associated with a lower quantity range;
means for prioritizing among the buyers within each set of buyers, a buyer that has requested a larger quantity of items being given a higher priority than a buyer that has requested a smaller quantity of items; and
means for allocating items among the group of buyers according to an algorithm such that:
each buyer within a higher-priority set of buyers is allocated an item quantity that is substantially equal to the quantity difference for the higher-priority set of buyers before buyers within a lower-priority set of buyers are allocated an item quantity that is substantially equal to the quantity difference for the lower-priority set of buyers, and
items are allocated among buyers within a set of buyers in a series of rounds in which a higher-priority buyer within the set of buyers is allocated a pre-determined quantity of items substantially matching the one or more preferences for the higher-priority buyer before a lower-priority buyer within the set of buyers is allocated the pre-determined quantity of items substantially matching the one or more preferences for the lower-priority buyer, the pre-determined quantity of items being substantially less than the quantity difference for the set of buyers, each round continuing until every buyer within the set of buyers has been allocated the pre-determined quantity of items in the round, the series of rounds continuing until each buyer within the set of buyers has been allocated a quantity of items substantially equal to the quantity difference for the set of buyers.
